(19) United States
(12) Patent Application Publication
(10) Pub. No.: US 2010/0130263 A1
(43) Pub. Date: May 27, 2010

(54) SYSTEM AND METHOD FOR DUAL POWER SOURCE MANAGEMENT

(76) Inventors: Edward Zhang, Ningbo (CN); Steven Zhou, Shanghai (CN); Jason Sun, Shanghai (CN)

Correspondence Address: GRAYBEAL JACKSON LLP, 400 - 108TH AVENUE NE, SUITE 700, BELLEVUE, WA, 98004, US

(21) Appl. No.: 12/276,057

(22) Filed: Nov. 21, 2008

(51) Int. Cl. H04B 1/38

(52) U.S. Cl. 455/572

(57) ABSTRACT

A system and method for providing power to a mobile device from two power sources. According to embodiments described herein, a mobile device, such as a cell phone, may include a main battery and an auxiliary battery. The mobile device includes a power management circuit that utilizes a charge-control circuit and a power-selection circuit for implementing a power-management schema. The charge-control circuit may exclusively couple the main battery or the auxiliary battery to an external power source for charging. The power-selection circuit may exclusively couple the main battery or the auxiliary battery for providing power to the mobile device. The system further includes a controller that controls the coupling of the main battery and the auxiliary battery such that if the main battery falls below a sufficient voltage level, the auxiliary battery may be immediately engaged without interruption of the operation of the mobile device.

### BACKGROUND

Mobile devices, such as mobile phones and media players, are prevalent in many aspects of a modern lifestyle. It is often the case that these devices are called upon to constantly function, i.e., to be constantly “on.” For example, a person's mobile phone may be required to be on at all times so that the person may be reached. As a result, the power source (e.g., a battery) required to provide power to the device needs to be long-lasting and easily replenished.

Typically, a mobile device, i.e., a device that can operate for an exact period of time without drawing power from an AC source, such as a wall outlet, will have one or more batteries to provide power. A battery provides a DC power source to the mobile device and has a life that is indirectly proportional to the current load drawn by the mobile device. As current is drawn from the battery, its charge is eventually depleted and, therefore, the battery must be recharged, typically by using a charging device that plugs into a power source, such as a wall outlet or automobile power outlet. The development of better batteries has led to longer battery life and shorter recharging time.

Nevertheless, there are many times that a mobile device will deplete its battery before one is able to get to a location where one can recharge the battery. Thus, a user of a mobile device may choose to carry a second battery or even have a mobile device that utilizes two batteries. This allows a user to remove and charge one battery while the other battery is used in the mobile device. Whether the user swaps batteries or manually switches in a second battery that is already installed in the mobile device, a number of problems may exist.

For example, if a user needs to swap one battery for another, the mobile device must be powered down in order to remove the deployed battery. (That is, as soon as the battery in operation is removed, the mobile device immediately ceases operation since it has no power source.) As a result, the mobile device is not operational during the battery swap. For a mobile device, such as a mobile phone that is the only means of communication for a user, any downtime required for battery change may be unacceptable. Furthermore, some mobile devices have security measures in place for sounding an alarm if an unauthorized person attempts to remove various parts (e.g., SIM card, memory card) of the mobile device. Thus, if the single battery is removed and all operations cease, the device may not be able to sound an alarm if an unauthorized person is trying to remove, e.g., the device's SIM card or memory card.

Mobile devices that employ dual batteries may have other problems. One problem with dual-battery devices is that the devices typically require an extra power-management integrated circuit (IC) having its own dedicated processor to manage both batteries. An extra IC takes up extra space and adds cost and power consumption to the mobile device. Furthermore, the use of the additional power management IC may require use of additional inputs and outputs from a main processing unit (e.g., a base band IC of a base band chip set (BBCS) thus preventing the use of these inputs and outputs for other purposes.

### BRIEF DESCRIPTION OF THE DRAWINGS

The foregoing aspects and many of the attendant advantages of the subject matter disclosed herein will become more readily appreciated as the same become better understood by reference to the following detailed description, when taken in conjunction with the accompanying drawings, wherein:

FIG. 1 is a block diagram of an embodiment of a dual power source management system.

FIG. 2 is a schematic diagram of an embodiment of a charge-control circuit that may be part of the dual power source management system of FIG. 1.

FIG. 3 is a schematic diagram of an embodiment of power selection circuit that may be part of a dual power source management system of FIG. 1.

FIG. 4 is a schematic diagram of an embodiment of power-source selection control circuit that may be part of the dual power source management system of FIG. 1.

### DETAILED DESCRIPTION

The following discussion is presented to enable a person skilled in the art to make and use the subject matter disclosed herein. The general principles described herein may be applied to embodiments and applications other than those detailed below without departing from the spirit and scope of the subject matter disclosed herein. This disclosure is not intended to be limited to the embodiments shown, but is to be accorded the widest scope consistent with the principles and features disclosed or suggested herein.

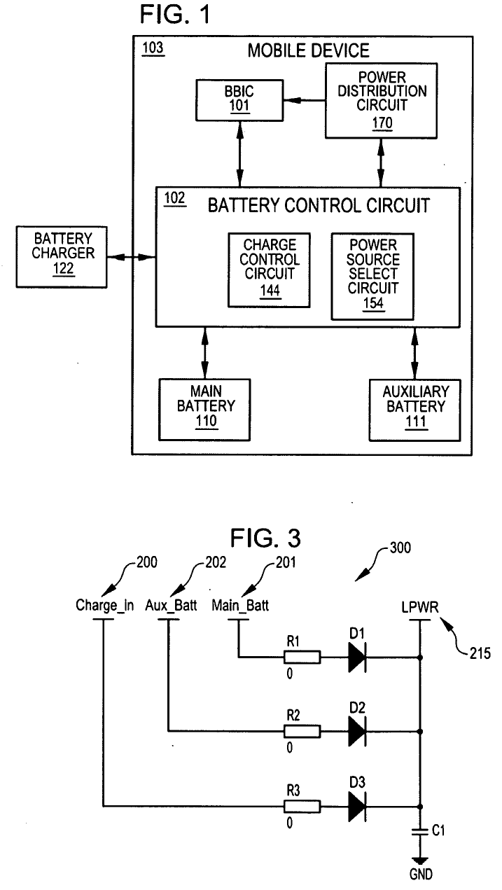

FIG. 1 is a block diagram of an embodiment of dual power source management system 100. The system 100 may be disposed in a mobile device 103 such as a cell phone, and may form part of a power-management schema for the mobile device. Such a power-management schema may be implemented and controlled by a central processing unit (CPU) for the entire mobile device, often called the base-band integrated circuit (BBIC) 101. The BBIC 101 may be one of multiple ICs in one package that may collectively be called a base-band chip set (BBCS). The BBIC 101 may include various General Purpose Input/Output Pins (GPIO) as well as various Analog-to-Digital converter Input pins (ADC). As with any IC, the number of these pins may be limited because of size and cost issues.

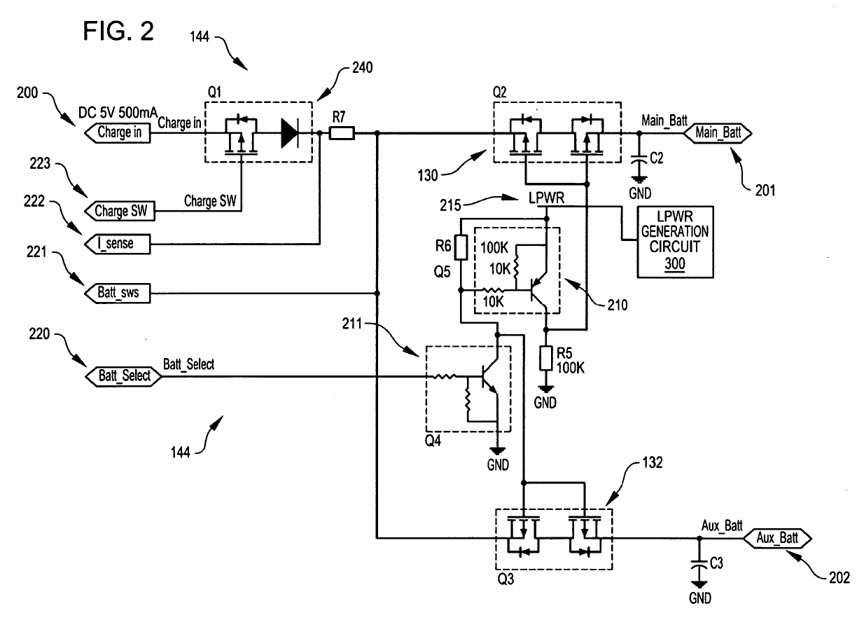

Although shown as a single line connection between the BBIC 101 and a battery-control circuit 102, it is understood that several electronic connections may be encompassed within this graphical illustration. In an embodiment of the mobile device 103, there are just three GPIO pin connections and two ADC pin connections between the BBIC 101 and the battery-control circuit 102 as described below in conjunction with FIGS. 2-4. Implementing a power-management schema with relatively few connections to the BBIC 101 may be an advantage over power-management schemas of the past because of the lower number of control connections. Furthermore, the battery-control circuit 102 may be smaller, less complex, and may consume less power than a dedicated power-management I.

The system 100 may typically include two batteries, a main battery 110 and an auxiliary battery 111. The is no implied meaning from the name of these batteries to suggest that one is more powerful than the other or one that is in use more than the other. In fact, these batteries may be identical to each other in size, shape, and electrical characteristics. A suitable battery for use in the mobile device 103, such as the batteries 110 and 111, may be a conventional nickel-cadmium battery or a conventional lithium-ion battery.

Each battery may be connected to or disconnected from various circuits in the system 100. A charge-control circuit 144 within the battery-control circuit 102 may be used to charge either the main battery 110 or the auxiliary battery 111 (when installed). When either battery 110 or 111 is coupled to the charge-control circuit 144, the respective coupled battery may be charged by an external battery charger 122 such as from AC current drawn from a typical wall outlet or from any other power outlet (e.g., in a car, a plane). Similarly, a power-select circuit 154 may couple one or the other battery to a power-distribution circuit 170 which supplies power to the BBIC 101, battery-control circuit 102 and other components of the mobile device 103. The nature and operation of such couplings is described in greater detail below with respect to FIGS. 2-4.

In an embodiment, during operation, one of the batteries 110 and 111 may be coupled to the charge-control circuit 144 while the other battery is coupled to the power-distribution circuit 170. However, there may be operational modes where both batteries are uncoupled from the charge-control circuit 144 (i.e., both batteries 110 and 111 are fully charged), both batteries 110 and 111 are uncoupled from the power distribution unit 170 (i.e., the mobile device 103 is powered by the battery charger 122), or both batteries 110 and 111 may be coupled to the battery charger 122 (wherein the battery charger 122 is acting as an AC-to-DC adapter). Various operations and modes for coupling batteries to these components are discussed in more detail below.

FIG. 2 is a schematic diagram of a charge-control circuit 144 that may be part of the dual power source management system 100 of FIG. 1 according to an embodiment of the subject matter disclosed herein. In this circuit 144, a determination is made as to which battery may be connected to the charge-control circuit 144 at a charge terminal 200. The main battery (not shown in FIG. 2) may be electrically connected at the main battery terminal 201. Similarly, the auxiliary battery (not shown in FIG. 2) may be electrically connected at the auxiliary battery terminal 202. Other signals used to make this determination include a charge switch signal 223, a current sense signal 222, a battery charging signal 221 and a battery selection signal 220, all of which are discussed further below.

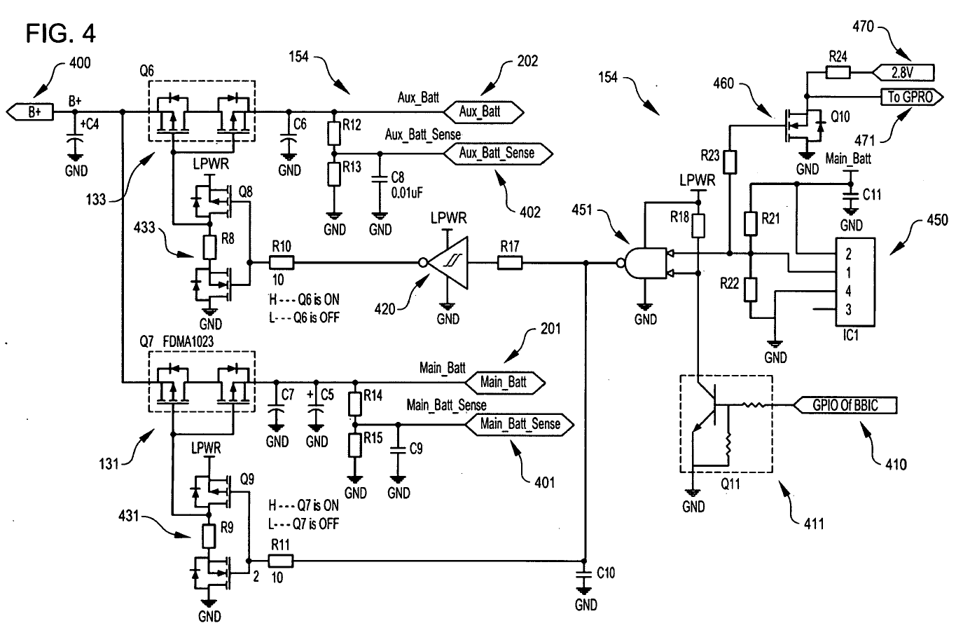

The battery-selection signal 220 selects one battery or the other to couple to the charge signal 200. The battery-selection signal 220 may be generated by the BBIC 101 at one of its GPIO pins. A system designer may program the BBIC 101 to select which battery to charge and when according to any criteria desired. As but one example, a designer may monitor an auxiliary battery sense signal and main battery sense signal (both shown in FIG. 4 and discussed further below). Then, the BBIC 101 may determine which of the batteries exhibits a lower voltage sense signal and thereby select the lowest charged battery for charging. Other scenarios are contemplated as part of an overall power-management schema as discussed further below.

In an embodiment, the selection of using one battery over the other is determined by the logical value of the battery selection signal 220. If the battery selection signal 220 is a logical high signal, then the transistor Q4 211 and transistor Q5 210 are turned on. In turn, the gates of each of the p-channels MOSFETS of switch 132 are pulled low via the transistor Q4 and this closes the switch 132. As a result, the auxiliary battery terminal 202 is coupled to the charge signal 200 such that the auxiliary battery 111 is charged. Therefore, if the charge switch signal 223 is a logical low signal, which is to say, an AC power is present (e.g., the mobile device is plugged into an external power source and senses a signal at the charge switch signal terminal 220), then the auxiliary battery 111 coupled to the auxiliary battery terminal 202 will begin receiving a charge from the charge signal 200. Further, switch 130 remains open as the gates of the p-channel MOSFETS are driven high from the current through transistor 210. This uncouples of the main battery 110 from the auxiliary battery 111 while the auxiliary battery 111 is being charged. The p-channel MOSFETS of the switch 130 have their bodies biased in such a way as to implement back-to-back connected body diodes that electrically isolate the main battery 110 from the auxiliary battery 111.

In a similar but opposite manner, if the battery selection signal 220 is a logical low signal (e.g., 0 V), then the transistor Q4 211 and transistor Q5 210 are turned off. In turn, the gates of each of the p-channels MOSFETS of switch 130 are pulled low (via the ground path through resistor R5) which closes s this switch 130. As a result, the main battery terminal 201 is coupled to the charge signal 200. Therefore, if the charge switch signal 223 is a logical low signal, then the main battery 110 coupled to the main battery terminal 201 will be charged via the charge signal 200. Further, switch 132 remains open as the gates of the p-channel MOSFETS are pulled up from via the resistor R6. This uncouples the auxiliary 111 battery from the main battery 110 while the main battery 110 is being charged. Similar to above, the p-channel MOSFETS of the switch 132 have their bodies biased in such a way as to implement back-to-back connected body diodes that electrically isolate the main battery 110 from the auxiliary battery 111.

The power-management schema embodied in the charge-control circuit 144 of FIG. 2 may offer a number of advantages over conventional systems. As discussed above, the switches 130 and 132 are realized as p-channel MOSFETs with back-to-back body diodes. Such dual p-channel MOSFETs may be found in a FDMA1023PZ IC available from Fairchild Semiconductor™. Because of the back-to-back body diodes, when each p-channel MOSFET transistor is off, negligible or no reverse current from whichever of the main battery 110 or auxiliary battery 111 is uncoupled from the charge signal 200. With any reverse current being rendered negligible, the main and auxiliary batteries 110 and 111 are sufficiently isolated to prevent any damage that may be caused if the batteries are coupled to each other.

In yet another potential advantage of the power-management schema described with respect to FIG. 2, automatic switching between utilizing and charging the main battery 110 or the auxiliary battery 111 may be realized. Furthermore, if an attempt at removing the main battery 110 in order to remove other components, such as a SIM card, the auxiliary battery 111 may still be engaged to execute security measures.

FIG. 3 is a schematic diagram of an embodiment of a power source selection circuit 300 for generating the voltage, LPWR 215 of FIGS. 2 and 4 that may be part of a dual power source management system 100 of FIG. 1. This circuit 300 assures that LPWR 215 is generated from the highest of the three sources; the main battery 110, the auxiliary battery 111 and the charge signal 200. By being able to be generated by any of these three power sources, the circuit 144 (and circuit 154 of FIG. 4) can operate if one of these sources is not present.

FIG. 4 is a schematic diagram of an embodiment of the power-source selection circuit 154 that may be part of the dual power source management system 100 of FIG. 1. The power-source selection circuit 154 monitors the voltage level of each battery (main 110 and auxiliary 111) and depending on which of the batteries is under load, may switch to the other if necessary. A resistor divider (comprising resistors R14 and R15) provides a main battery sense signal 401 and another resistor divider (comprising resistors R12 and R13) provides an auxiliary battery sense signal 402. The main battery sense signal 401 and the auxiliary battery sense signal 402 are provided to the BBIC 101 via the two ADC pins used for the power-management schema for the dual power management system and used to determine which battery may need charging and which battery to use as the power source for the mobile device 103.

As discussed above, the BBIC 101 utilizes various signals to determine a power management scheme. Thus, if it is determined that the main battery 110 will be used to power the mobile device, the BBIC 101 closes the switch 131 (to connect the main battery terminal 201 to the B+ voltage terminal 400) and opens the switch 133 (to disconnect the auxiliary battery terminal 202 from the B+ voltage terminal 400). Likewise, if the power-management schema determines that the auxiliary battery 111 will be used, the BBIC 101 closes switch 133 and opens switch 131. The remaining circuitry of the power-source selection circuit 154 assures that the switching between batteries is fast and efficient.

The respective switches that engage or disengage the main and auxiliary batteries 110 and 111 are controlled by a signal from the output of a NAND gate 451. Based upon the input to the NAND gate 451, the resulting output signal will either be a logical high value or a logical low value. A logical high value at the NAND gate 451 output corresponds to engaging (for load) the main battery 110 and disengaging the auxiliary battery 111, while a logical low signal at the NAND gate 451 output corresponds to engaging the auxiliary battery 111 and disengaging the main battery 110.

In greater detail, if the NAND gate 451 output is a logical high signal, then the inverter 431 outputs a logical low signal. In turn, the gates of each of the p-channels MOSFETs of Q7 (i.e., switch 131) are pulled low, which closes this switch 131. As a result, the main battery terminal 201 is coupled to the B+ voltage terminal 400. Further, with a logical high signal from the NAND gate 451, a logical low signal emanates from the output of a coupled Schmitt trigger 420 (which also inverts the signal). This low logical signal causes the driver 433 to output a logical high signal and the switch 133 remains open as the gates of the p-channel MOSFETs of Q6 (i.e., switch 133) are pulled high. This electrically isolates the auxiliary battery 111 from the B+ terminal 400 while the main battery 110 is being engaged to provide power to the B+ terminal 400.

In a similar but opposite manner, if the NAND gate 451 output is a logical low signal, a logical high signal is output from the coupled Schmitt trigger 420. Therefore, the driver 433 outputs a logical low signal. In turn, the gates of each of the p-channels MOSFETs of Q6 (i.e., switch 133) are pulled low, which closes this switch 133. As a result, the auxiliary battery terminal 202 is coupled to the B+ voltage terminal 400. Further, the logical low signal from the output of the NAND gate 451 causes the driver 431 to output a logical high signal, which causes the switch 131 to remain open as the gates of the p-channel MOSFETs of Q7 (i.e., switch 131) are pulled high. This electrically isolates the main battery 110 from the B+ terminal 400 while the auxiliary battery 111 is being engaged to provide power to the B+ terminal 400.

The Schmitt trigger 420 assures that the leading edge of the logical high signal that turns on the switch 133 (i.e., Q6) does so in a relatively fast manner. Thus, the Schmitt trigger 420 turns the switch 133 on fast enough to prevent power loss failure in the mobile device. Having such a Schmitt trigger 420 at this coupling provides fast switching (under 20 nanoseconds) when transitioning from having the main battery providing power to the B+ terminal 400 to having the auxiliary battery provide this power and vice versa.

The inputs of the NAND gate 451 are determined as part of the programmable power-management schema as described herein. A programmable GPIO pin from BBIC 410 may be used to provide logical high signals and logical low signals as part of the power-management schema and may be programmed by an end user accordingly. In one power-management schema, an end user may program a GPIO pin of BBIC 410 to control Q11 for switching the power-source to auxiliary battery 111 when the main battery 110 voltage falls below a certain threshold. Thus, when the main battery sense signal 401 falls below the threshold, a logical high signal is output from the GPIO pin of BBIC 401, so Q11 411 is on and the Pin1 of the NAND gate 451 is low. Any logical low signal at any input of the NAND gate 451 will cause its output to be a logical high value. As described above, a logical high signal at the output of the NAND gate 451 will open the switch 131 that engages the main battery 110 and close the switch 133 that engages the auxiliary battery 111. So therefore, when the main battery 110 falls below the threshold, the power-management schema automatically switches in the auxiliary battery 111 within 20 nanoseconds of disconnecting from the main battery 110 and also assures that the main battery 110 is disengaged before the auxiliary battery 111 is engaged. Such a fast changing from one battery to the next assures that no lapse in operation of the mobile device 103 is experienced. Further, one may even perform a “hot swap” of one of the batteries, even if it is providing power to the B+ terminal 400 when removed.

As the auxiliary battery 111 is engaged, it is desired to not immediately switch back to the main battery 110. Such switching back to the main battery 110 may occur if its sensed voltage rises above a threshold, which may be due to recharging the main battery or by removing the load (e.g., power supplied to the mobile device 103) from pulling its voltage lower. If there is no prevention of immediately switching back to the main battery 110, a problem arises wherein switching back to loading the main battery 110 may occur rapidly and repeatedly. It may be advantageous to fully charge the main battery 110 before switching back again or to deplete the auxiliary battery 111 below its respective threshold before switching. Again, these options may be programmed by an end user according to a desired power-management schema.

As such the power-selection circuit 154 provides circuitry for the prevention of such rapid and repeated switching. The transistor Q10 460 provides a battery switch pulse signal 471 to one of the GPIO pins of the BBIC 101. When IC1 450 outputs a logical low signal on pin 1, the transistor Q10 460 turns off which sends a battery switch pulse signal 471 to the BBIC 101. The BBIC 101 senses this and, in response, outputs a logical high signal to another one of the GPIO pins 410 used. This pin provides an auxiliary battery lock-in signal 410 and is coupled to the input of a transistor Q11 411. This signal 410 will cause the transistor Q11 to pull a logical low signal at a second input of the NAND gate 451. Having a second logical low signal at an input to the NAND gate 451 prevents the circuit 154 immediately reengaging the main battery 110 even if pin 1 of IC1 450 returns to a logical high signal in response to the voltage at the main battery 110 recharging to exceed a threshold to once again provide power to the B+ terminal 400.

The power-management schema may be configured at the BBIC 101 to not remove the auxiliary lock-in signal 410 (i.e., switch from a logical high signal to a logical low signal) e.g., for a specific time period (e.g., three hours), until the mobile device 103 is plugged in to an external power source, or until the main battery 110 is sensed to be charged to full capacity. Further, the transistor Q10 460, in addition to providing a means for preventing rapid and repeated battery switching can also provide a notification signal that the main battery 110 has been discharged. Thus, the BBIC 101 may be configured to turn on an LED that indicates to a user that the main battery has been depleted. This may also indicate that when the mobile device 103 is plugged in for recharging, the user can be assured that the main battery 110 is receiving the charge first.

During startup, the power-source selection circuit 154 works in a similar manner. The IC1 450 may be a voltage detector IC with high detector threshold accuracy and an ultra-low supply current. IC1 450 may also have a series fixed voltage detector threshold, such that the end user may select one fixed detector threshold based on a system voltage threshold. When the mobile device 103 is first powered up, the voltage at the main battery 110 may be sensed via IC1 450 first and if the main battery 110 voltage is below a respective threshold, the power-management schema may cause the auxiliary battery 111 to be engaged initially. Similar to above, the lack of a sufficiently high enough voltage initially at the main battery 110 causes the IC1 450 to output a logical low signal on pin 1. Just as if the main battery 110 had transitioned from a sufficient voltage to below a threshold voltage, the transistor Q10 460 turns off, which sends a battery switch pulse signal 471 to the BBIC 101. The BBIC 101 senses this and, in response, outputs a logical high signal to another one of the GPIO pins 410 used. This pin provides an auxiliary battery lock-in signal 410 and is coupled to the input of a transistor Q11 411. This signal 410 will cause the transistor Q11 to pull a logical low signal at a second input of the NAND gate 451.

Thus, even if the main battery 110 is below the voltage threshold, at a zero-charge level, or perhaps is not even installed, the power-management schema allows for the immediate engaging of the auxiliary battery 111. This is accomplished because resistor R22 pulls pin 1 of IC1 450 to a logical low signal is input to the NAND gate 451. As before, any logical low signal at the NAND gate 451 engages the auxiliary battery 111.

While the subject matter discussed herein is susceptible to various modifications and alternative constructions, certain illustrated embodiments thereof are shown in the drawings and have been described above in detail. Furthermore, those skilled in the art will understand that various aspects described in less than all of the embodiments may, nevertheless, be present in any embodiment. It should be understood, however, that there is no intention to limit the subject matter to the specific forms disclosed, but on the contrary, the intention is to cover all modifications, alternative constructions, and equivalents falling within the spirit and scope of the subject matter discussed herein.

What is claimed is:

1. An electronic circuit for managing two power sources, the circuit comprising:
a first terminal operable to be coupled to a first chargeable power source;
a second terminal operable to be coupled to a second chargeable power source; and
a power-source selection circuit operable to:
couple the first terminal to a power supply terminal;
sense a voltage at the first terminal;
generate a power source selection signal if the sensed voltage falls below a threshold voltage; and
in response to the power source selection signal, decouple the first terminal from the power supply terminal and couple the second terminal to the power supply terminal.

2. The electronic device of claim 1, further comprising:
a first back-to-back p-channel MOSFET transistor switch for coupling the first terminal to the power supply terminal; and
a back-to-back p-channel MOSFET transistor second switch for coupling the second terminal to the power supply terminal.

3. The electronic device of claim 1, wherein the power selection circuit is further operable to:
sense a voltage at the second terminal after the second terminal is coupled to the power supply terminal;
generate a second power source selection signal if the sensed voltage at the second terminal falls below a threshold voltage; and
in response to the second power source selection signal, decouple the second terminal from the power supply terminal and couple the first terminal to the power supply terminal.

4. The electronic device of claim 1, further comprising a programmable logic circuit disposed in the power selection circuit and operable to lock-in the power source selection circuit until a predetermined condition is fulfilled.

5. The electronic circuit of claim 1 disposed on a single integrated circuit chip.

6. A method for selecting power source for a device, the method comprising:
providing power to a device in operation from a first power source;
sensing that the first power source falls below a threshold for providing power;
in response to the sensing; decoupling the first power source from the device; and
coupling a second power source to the mobile device within a predetermined amount of time such that the device remains in operation.

7. The method of claim 6 wherein the predetermined amount of time is approximately 20 nanoseconds.

8. The method of claim 6, further comprising coupling the first power source to a charging source in response to the sensing.

9. An electronic circuit for managing two power sources, the circuit comprising:
a first terminal operable to be coupled to a first chargeable power source;
a second terminal operable to be coupled to a second chargeable power source;
a charge-control circuit operable to exclusively couple the first terminal or the second terminal to a charge terminal; and
a power-source selection circuit operable to exclusively couple the first terminal or the second terminal to a power supply terminal.

10. A method for managing two power sources in an electronic device, the method comprising:
providing power to an electronic circuit that is in operation from a first power source, the power provided exceeding an operational threshold;
sensing that the power provided by the first power source falls below the operational threshold; and
in response to the sensing, decoupling the first power source from the electronic circuit and coupling a second power source to electronic circuit such that the operation of the electronic circuit is maintained.

11. The method of claim 10, further comprising coupling the first power source to a charging circuit in response to the decoupling from the electronic circuit.

12. The method of claim 11, further comprising:
sensing that the power provided by the second power source falls below the operational threshold; and
in response, decoupling the second power source from the electronic circuit and coupling the first power source to electronic circuit such that the operation of the electronic circuit is maintained.

13. The method of claim 11, further comprising:
sensing that the first power source is sufficiently charged to resume providing power to the electronic circuit at or above the operational threshold; and
in response, decoupling the second power source from the electronic circuit and coupling the first power source to electronic circuit such that the operation of the electronic circuit is maintained.

14. The method of claim 10, further comprising decoupling the first power source from the electronic circuit and coupling a second power source to electronic circuit within 20 nanoseconds.

15. A method for powering a mobile device, the method comprising:
initializing a mobile device having a first battery and a second battery, each operable to provide power to an electronic circuit;
sensing that the first battery cannot provide sufficient power to power the electronic circuit; and
in response to the sensing, automatically providing power from the second battery to the electronic circuit.

16. A mobile device, comprising:
a main battery operable to be charged and discharged;
an auxiliary battery operable to be charged and discharged;
a charge-control circuit operable to couple the main battery and the auxiliary battery to an external power source for charging the main battery and the auxiliary battery;
a discharge-control circuit operable to couple the main battery and the auxiliary battery to a power distribution unit for providing power to a mobile device from main battery and the auxiliary battery; and
a controller operable to control the coupling of the main battery and the auxiliary battery such that if the main battery is coupled to the power distribution unit, the auxiliary battery is not coupled to the power distribution unit.

17. The device of claim 16, wherein the controller is further operable to:
uncouple the main battery from the power distribution unit if the controller senses that a voltage level of the main battery falls below a low threshold; and
in response to the sensing below the low threshold, couple to the auxiliary battery to the power distribution unit within a timeframe that does not cease operation of the mobile device.

18. The device of claim 17 wherein the controller is further operable to:
maintain the coupling of the auxiliary battery to the power distribution unit until the voltage level of the main battery is sensed to be above a high threshold; and
in response to the sensing above the high threshold, uncouple the auxiliary battery from the power distribution unit and couple to the main battery to the power distribution unit within a timeframe that does not cease operation of the mobile device.

19. The device of claim 17 wherein the controller is further operable to:
maintain the coupling of the auxiliary battery to the power distribution unit until the voltage level of the main battery is sensed to be coupled to an external power source; and
in response to the sensing the external power source, uncouple the auxiliary battery from the power distribution unit and couple to the main battery to the power distribution unit within a timeframe that does not cease operation of the mobile device.

20. The device of claim 16, operable to determine the removal of the main battery while coupled to power distribution unit and, in response, couple the auxiliary battery to the power distribution unit within a timeframe that does not cease operation of the mobile device.

21. An electronic circuit, comprising:
a first terminal operable to be coupled to a first chargeable power source;
a second terminal operable to be coupled to a second chargeable power source;
a charge control circuit operable to:
couple the first terminal to a charge terminal;
sense a voltage at the first terminal;
generate a switch signal if the sensed voltage reaches a threshold voltage; and
in response to the switch signal, decouple the first terminal from the charge terminal and couple the second terminal to the charge terminal.
